(19) United States
(12) Patent Application Publication
(10) Pub. No.: US 2003/0024989 A1
(43) Pub. Date: Feb. 6, 2003

(54) Bar code reader

(76) Inventor: Hidekuni Aizawa, Kanagawa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/187,500

(22) Filed: Jul. 2, 2002

(30) Foreign Application Priority Data
Jul. 6, 2001 (JP) P2001-205978

(51) Int. Cl. G02B 5/08; G06K 7/10; G02B 26/00

(52) U.S. Cl. 235/462.36

(57) ABSTRACT

A bar code reader includes a light emitting element, a movable mirror operative, by oscillation, to reflect outgoing light from the light emitting element to cause reflected light to scan an object to be illuminated and to further reflect the reflected light of the outgoing light having illuminated the object, and a light receiving element arranged to detect the reflected light reflected off the movable mirror and convert a detected beam into an electrical signal. The movable mirror comprises a glass substrate and a dielectric multilayer film laminated on the glass substrate. The dielectric multilayer film is formed by alternating layers of a high refractive index material and a low refractive index material at an optical thickness λ/4, where λ is the wavelength of the outgoing light.

### CROSS REFERENCES TO RELATED APPLICATIONS

The present document is based on Japanese Priority Document JP 2001-205978, filed in the Japanese Patent Office on Jul. 6, 2001, the entire contents of which being incorporated herein by reference.

### BACKGROUND OF THE INVENTION

1. Field of the Invention

The present invention relates to a bar code reader provided with a movable mirror that causes light from a light emitting element to scan an object to be illuminated and also allows a light receiving element to detect reflected light from the illuminated object. More particularly, the present invention is directed to a bar code reader which is made smaller, lighter, and less expensive by improving the function of its movable mirror.

2. Description of Related Art

Many shops, plants and other facilities nowadays put bar codes on their goods and products for sales control and production management. These bar codes, each representing specific digital data, are read by optical scanning. To read digital information, a bar code of this type is usually exposed to light for detection of the intensities of light reflected therefrom, and the detected light intensities are then photo-electrically converted into electrical signals, a combination of which represents the digital information.

More specifically, in one of conventional bar code readers which is shown in the form of a conceptual representation in FIG. 7, light from a light emitting element 1 is focused by a light projection lens 3 and then reflected off a mirror 7 of a scan mirror (movable mirror) 5 to illuminate a bar code pattern 9, which is an object to be illuminated. For illumination of the entire part of this pattern 9, the mirror 7 is oscillated. Oscillations are caused by first inserting a magnet 11 secured to the mirror 7 into a driving coil 13 and then energizing the coil 13, for example, through cyclic application of positive and negative currents thereto, to move the magnet 11 in and out of the driving coil 13 for oscillating the mirror 7 around a pivot 15.

The light having illuminated the surface of the bar code pattern 9 returns to the mirror 7, through irregular reflections due to differing light intensities resulting from black and white bar code pattern segments. Beams of light reflected off the mirror 7 are then condensed by a condenser lens 17, so that a light receiving element 19 converts the differing light intensities into electrical energy as an output. In order to improve the reading accuracy, a band-pass filter (BPF) 21 is arranged on a front surface of the light receiving element 19 to prevent collection of any undesired light having frequencies other than emission frequency.

In the above conventional bar code reader in which the movable mirror oscillates to read bar codes, the movable mirror is typically made of a metallic reflector, such as an aluminum reflector, evaporated on a glass substrate. Bar code readers using a movable mirror of this type receive external light (extraneous light), such as light from room lamps and/or sunlight present around the mirror, along with reflected light from a bar code pattern, and the extraneous light other than the reflected light becomes noise that would impair the reading accuracy of these bar code readers if its level is so high that the reflected light cannot be properly extracted from all light beams received by the mirror.

To minimize the extraneous light level, the above conventional bar code reader employs the band-pass filter 21 arranged on a detecting side of the light receiving element as shown in FIG. 7, to block the noise-making extraneous light and transmit only beams of desired wavelengths, and exploits its oscillating movable mirror also to receive the reflected light by detecting such the reflected light as detectable only at a mirror angle defined at every instance of illumination.

However, if the band-pass filter is arranged in an optical path, space needs to be provided within the optical path, and this restricts the optical path length and hence prevents the downsizing of the bar code reader. If the band-pass filter is arranged independently as a dedicated functional part, parts and assembling costs increase. The band-pass filter, only serving to block light of undesired wavelengths and transmit light of desired wavelengths, is not capable of so-called “enhanced reflection” for reinforcing the light of desired wavelengths, and hence does fail to positively improve the reliability of bar code reading.

Moreover, a glass-based movable mirror in thin (lightweight) construction would require use of a special type of glass, thereby making a bar code reader expensive. Furthermore, due to contraction of its reflector film, this movable mirror is hard to achieve proper flatness, and its strength notably decreases as well (i.e., it is easily breakable).

### SUMMARY OF THE INVENTION

In order to solve the above problems, the present invention provides a bar code reader which requires no band-pass filter and which can achieve enhanced reflection whereby its size, weight, and costs can be reduced and reliability of bar code reading can be improved.

In a first embodiment, the present invention provides a bar code reader having a light emitting element; a movable mirror operative, by oscillation, to reflect outgoing light from the light emitting element to cause reflected light to scan an object to be illuminated and to further reflect the reflected light of the outgoing light having illuminated the object; and a light receiving element arranged to detect the reflected light reflected off the movable mirror and convert a detected beam into an electrical signal. In the bar code reader, the movable mirror comprises a glass substrate and a dielectric multilayer film laminated on the glass substrate. The dielectric multilayer film being formed by alternating layers of a high refractive index material and a low refractive index material at an optical thickness λ/4, where λ is a wavelength of the outgoing light.

According to this bar code reader, the movable mirror has the glass substrate and the dielectric multilayer film laminated on the glass substrate. Thus, any reflected light of the outgoing light traveling after emergence from the light emitting element is reflected from all the boundaries between the high and low refractive index materials of the dielectric multilayer film, causing the reflected light therefrom to reinforce each other in a phase to yield a higher reflectivity. That is, the movable mirror reflects only the outgoing light from the light emitting element at a high reflectivity through the reinforcement, and makes other rays of light (extraneous light) hard to reflect (or transmits them therethrough). This eliminates the use of a band-pass filter heretofore required for transmitting light having a desired wavelength band, and can thus implement a smaller, lighter, and less expensive bar code reader. The reflectivity yielded can be higher than those obtained with known metallic reflectors, and thus a further cost reduction can be achieved if a low-sensitivity, inexpensive light receiving element is used, whereas a better photosensitivity can be obtained if a photodetector as sensitive as conventional light receiving elements is used. Furthermore, the fact that only the desired band is positively enhanced-reflected provides a better barrier against extraneous light so as to improve bar code reading reliability.

In a second embodiment, the present invention provides a bar code reader having a light emitting element; a movable mirror operative, by oscillation, to reflect outgoing light from the light emitting element to cause reflected light to scan an object to be illuminated and to further reflect the reflected light of the outgoing light having illuminated the object; and a light receiving element arranged to detect the reflected light reflected off the movable mirror and convert a detected beam into an electrical signal. In the bar code reader, the movable mirror comprises a silicon substrate, and a metallic reflector film evaporated on the silicon substrate.

According to this bar code reader, in which the movable mirror has the silicon substrate and the metallic reflector film evaporated on the silicon substrate, the movable mirror can be made lighter and more rigid than when a glass substrate is used. That is, silicon is less dense and thus lighter than ordinary crown glass. Also, silicon has a higher strength (Young's modulus) than glass, and can hence make the mirror thinner under the same strength requirements. Thus, the movable mirror made of the silicon substrate can be lighter, and can reduce power consumption for driving to potentially implement a smaller driving means, and a bar code reader can hence become smaller and lighter. The lightweight movable mirror may feature high-speed driving and higher response. In addition, the increased strength of the mirror substrate will give improved impact resistance. Moreover, the silicon substrate of the movable mirror can be ground in the form of wafer using any existing equipment to allow for easy thickness adjustment, and can hence be produced in an easier and less expensive way than a glass substrate which requires use of a flat and thin special glass sheet.

In a third embodiment, the present invention provides a bar code reader having a light emitting element; a movable mirror operative, by oscillation, to reflect outgoing light from the light emitting element to cause reflected light to scan an object to be illuminated and to further reflect the reflected light of the outgoing light having illuminated the object; and a light receiving element arranged to detect the reflected light reflected off the movable mirror and convert a detected beam into an electrical signal. In the bar code reader, the movable mirror comprises a silicon substrate and a dielectric multilayer film laminated on the silicon substrate. The dielectric multilayer film being formed by alternating layers of a high refractive index material and a low refractive index material at an optical thickness λ/4, where λ is a wavelength of the outgoing light.

According to this bar code reader, the movable mirror has the silicon substrate and the dielectric multilayer film laminated on the silicon substrate. Thus, similarly to the bar code reader according to the first embodiment, this bar code reader can provide advantages, i.e., a high reflectivity, and smaller, lighter, and less expensive implementations. A further cost reduction can be achieved if a low-sensitivity, inexpensive light receiving element is used, whereas an increased photosensitivity can be obtained if the light receiving element has the same sensitivity as any known light receiving element. Moreover, an active enhanced reflection of only those beams having a target wavelength band can make the bar code reader less susceptible to extraneous light than ever before, to improve the reliability of bar code reading.

Furthermore, use of the silicon substrate provides advantages similar to the bar code reader according to the second embodiment. That is, the movable mirror can be lighter in weight and more rigid than that made of a glass substrate. The lighter structure of the movable mirror formed of the silicon substrate will help reduce driving power consumption, which in turn permits use of a smaller driving means for realization of a smaller, lighter bar code reader. The lighter movable mirror also permits high-speed and high-response operation. The highly strong mirror substrate made of silicon is also highly impact resistant, and its thickness is readily adjustable using any existing equipment, allowing for easier and less expensive fabrication, as compared to mirror substrates made of special glass.

Still another advantage of this bar code reader is that the silicon substrate produces less noise within the movable mirror than a glass substrate. When stacked on a glass substrate, a reflector such as the dielectric multilayer film may sometimes produce, unlike, for example, an aluminum reflector which is less light-transmissive and hence less problematical, unreflected rays of light which, transmitting through the dielectric multilayer film, enter the glass substrate to become unwanted light affecting optical signals as noise through reflection from the lower surface of the glass substrate. By contrast, the silicon substrate, which is less light-transmissive than the glass substrate, produces no such unwanted light as produced by the glass substrate, even when combined with the dielectric multilayer reflector film. Thus, this bar code reader can reduce noise in the movable mirror and hence improve its bar code reading reliability remarkably.

### BRIEF DESCRIPTION OF THE DRAWINGS

FIG. 1 is a conceptual representation of a bar code reader according to a first embodiment of the present invention;

FIG. 2 is a sectional view of a major portion of a movable mirror;

FIG. 3 is a diagram illustrating a principle of reflection by interference;

FIG. 4 is a graph showing transmittance of the movable mirror by wavelength;

FIG. 5 is a sectional view of a major portion of a movable mirror of a bar code reader according to a second embodiment of the present invention;

FIG. 6 is a sectional view of a major portion of a movable mirror of a bar code reader according to a third embodiment of the present invention; and

FIG. 7 is a conceptual representation of a conventional optical reading system.

### DESCRIPTION OF THE PREFERRED EMBODIMENTS

Bar code readers according to preferred embodiments of the present invention will now be described with reference to the attached drawings.

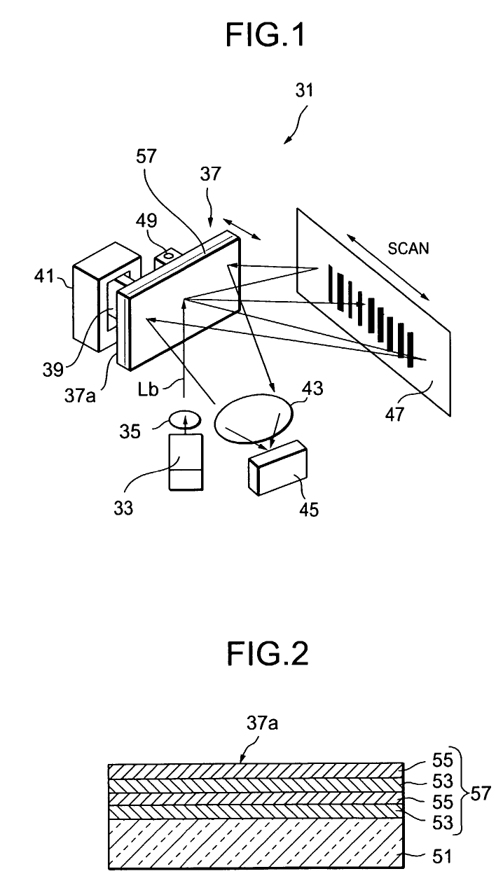

As shown in FIG. 1, a bar code reader 31 according to a first embodiment of the invention comprises, as its major elements, a light emitting element 33, a light projection lens 35, a movable mirror 37, a magnet 39, a driving coil 41, a condenser lens 43, and a light receiving element 45.

In this bar code reader 31, light from the light emitting element 33 is focused by the light projection lens 35 and then reflected off a mirror 37a of the movable mirror 37 to illuminate a bar code pattern 47, which is an object to be illuminated. For illumination of the entire part of this pattern 47, the mirror 37a is oscillated. Oscillations are caused by first inserting the magnet 39 secured to the mirror 37a into the driving coil 41 and then energizing the coil 41, for example, through cyclic application of positive and negative currents thereto, to move the magnet 39 in and out of the driving coil 41 for oscillating the mirror 37a around a pivot 49.

The light having illuminated the surface of the bar code pattern 47 returns to the mirror 37a, through irregular reflections due to differing light intensities resulting from black and white bar code pattern segments. Beams of light reflected off the mirror 37a are then condensed by the condenser lens 43, so that the light receiving element 45 converts the differing light intensities into electrical energy as an output.

In the bar code reader 31 which operates as mentioned above, the mirror 37a of the movable mirror 37 is comprised of a glass substrate 51 laminated on a dielectric multilayer film 57, as shown in FIG. 2. The dielectric multilayer film 57 is formed by alternating layers of a high refractive index material 53 and a low refractive index material 55, each layer having an optical thickness of λ/4, where λ is the wavelength of outgoing light Lb (see FIG. 1). The number of layers of the dielectric multilayer film 57 may be selectable depending on a desired reflectivity (transmittance).

The high refractive index material 53 may include TiO₂, ZrO₂, and ZnS. The low refractive index material 55 may include SiO_{2 and ThF}₄. In this embodiment, titanium oxide (TiO₂) as the high refractive index material 53 and silicon oxide (SiO₂) as the low refractive index material 55 are used in layers to form the dielectric multilayer film 57. Specifically, the layers (each being about 0.1625 μm thick) are evaporated as alternated one upon another, with their total thickness properly adjusted (to 2 μm in this embodiment) so as to match the output wavelength (650 nm in this embodiment) from the light emitting element 33, before laminated on the glass substrate 51 (0.5 mm thick in this embodiment) as the dielectric multilayer film 57.

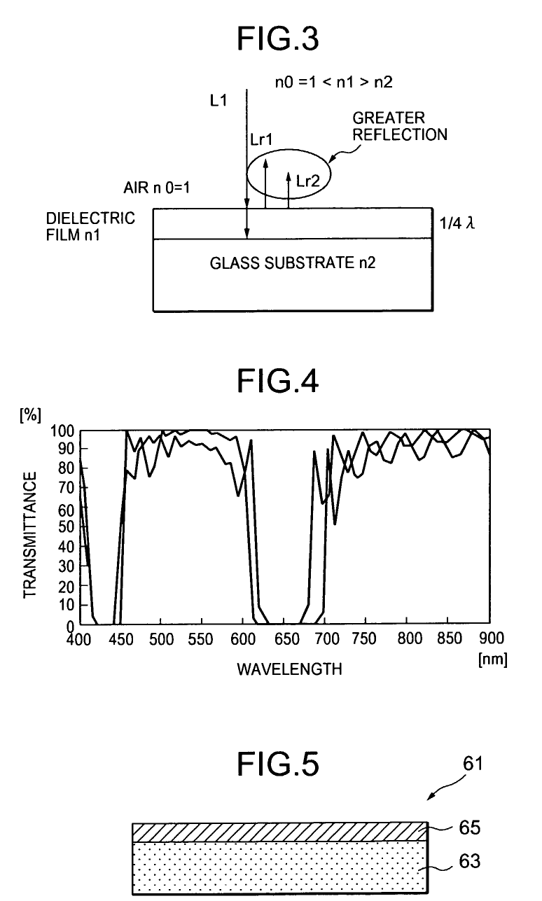

The dielectric multilayer film 57 yields high reflectivity via optical interference. As shown in FIG. 3, assuming that the refractive index of air is n0=1, that of a dielectric film is n1, and that of a glass substrate is n2, then n0<n1>n2. Hence, of light L1 whose wavelength is λ, a beam Lr1 reflected from the upper surface of the dielectric film has its phase inverted by 180°, and a beam Lr2 reflected from the boundary between the dielectric film and the glass substrate has, making a round trip through the ¼λ thick film, its phase changed to ½λ at the time of its emergence from the dielectric film. The beams Lr1 and Lr2 reinforce each other to yield a high reflectivity. Thus, in the dielectric multilayer film 57, beams reflecting from all the boundaries add up in phase, whereby a high reflectivity can be obtained. The dielectric multilayer film 57 can control the center wavelength by the thickness of each of its layers and the reflectivity (transmittance) by the number of layers.

As seen in FIG. 4, the dielectric multilayer film 57 that was prepared for this embodiment exhibited good reflection only for a band whose center wavelength is 650 nm. In FIG. 4, the ordinate shows transmittance in %, and the abscissa shows wavelength in nm. A transmission blocking band is around 650 nm, which is thus a high-reflection band. The dielectric multilayer film 57, because of its excellent reflectivity, provides an even higher reflectivity (98.5% or higher) than the reflectivity (about 96.5%) achieved by conventional enhanced reflector films on aluminum.

Thus, use of the movable mirror 37 made of the glass substrate 51 and the dielectric multilayer film 57 potentially provides efficient reflection and additionally blocks transmission of beams of light other than those having a desired wavelength. Hence, a band-pass filter is no longer needed.

According to the bar code reader 31, the movable mirror 37 is formed of the glass substrate 51 and the dielectric multilayer film 57. Thus, reflected light L1 of the light traveling after emergence from the light emitting element 33 is reflected from all the boundaries between the high and low refractive index materials 53 and 55 of the dielectric multilayer film 57, causing the reflected light therefrom to reinforce each other in phase to yield a higher reflectivity. Hence, the movable mirror 37 reflects only the light exiting from the light emitting element 33 at a high reflectivity through the reinforcement, and makes other rays of light (extraneous light) hard to reflect (or transmits them therethrough). This eliminates the use of a band-pass filter heretofore required for transmitting light having a desired wavelength band, and can thus implement a smaller, lighter, and less expensive bar code reader 31. The reflectivity yielded can be higher than those obtained with metallic reflectors, and thus a further cost reduction can be achieved if a low-sensitivity, inexpensive light receiving element 45 is used, whereas an enhanced photosensitivity can be obtained if a light receiving element as sensitive as conventional light receiving elements is used. Furthermore, the fact that only the desired band is positively enhanced-reflected provides a better barrier against extraneous light so as to improve bar code reading reliability.

Referring next to FIG. 5, a bar code reader according to a second embodiment of the present invention will be described.

As shown in the figure, this bar code reader is characterized by constructing a movable mirror 61 of a silicon substrate 63 and a metallic reflector film (aluminum evaporated reflector film) 65 evaporated on the silicon substrate 63. While the density of conventionally used ordinary crown glass (any BK7 equivalent) is 2.55 g/cm³, that of silicon is 2.33 g/cm³ and thus smaller. This means that the movable mirror would be lighter if made of the silicon substrate 63 rather than of a crown glass substrate as long as both substrates are of a size. The lighter mirror can reduce power consumed by its actuator.

In addition, the strength (or Young's modulus) of conventionally used ordinary crown glass is 71.5 KN/mm², whereas that of silicon is 190 KN/mm². Thus, silicon is stronger than glass, and can make the mirror thinner under the same strength requirements.

Referring here to Table 1 below, the flatness will be discussed of mirror samples, each of which was made of a glass or silicon substrate and mirror-polished in various manners. Each sample measured 6 mm×9 mm. Aluminum enhanced reflector films and dielectric multilayer films were mirror-polished, and their flatnesses were evaluated in p-v (peak-to-valley) value.

TABLE 1

| Thickness | P-V Value | | |
|---|---|---|---|
| (mm) | (wave) | Mirror-Polished | Substrate |
| 0.3 | 1.381-1.425 | A | C |
| 0.3 | 0.821-0.993 | D | C |
| 0.4 | 0.985-1.520 | D | N |
| 0.5 | 0.105-0.175 | D | C |
| 0.3 | 1.197-1.479 | A | S |
| 0.3 | 0.289-0.635 | D | S |

A: Aluminum enhanced reflector film
D: Dielectric multilayer film
C: Crown glass
N: Neoceram special glass
S: Silicon

Generally, the smaller its p-v value, the more flatter a mirror sample, and the thinner, the more deformable. In this embodiment, the samples having a reflective surface made of a less shrinkable aluminum film exhibited no difference, whether their substrate is glass or silicon, whereas for the samples having a reflective surface made of a dielectric film, the silicon substrate was less deformable than the glass substrate. That is, the above findings teach that a silicon substrate demonstrates remarkable effects when combined with a dielectric reflector.

According to this bar code reader, in which the movable mirror is formed of the silicon substrate 63 and the metallic reflector 65 evaporated on the substrate 63, the movable mirror can be made lighter and more rigid than when a glass substrate is used. Thus, the movable mirror made of a silicon substrate can be lighter, and can reduce power consumption for driving to potentially implement a smaller driving means, and hence a bar code reader can be smaller and lighter. The lightweight movable mirror may feature high-speed driving and hence higher response. In addition, the increased strength of the mirror substrate will give improved impact resistance. Moreover, the silicon substrate of the movable mirror can be ground in the form of wafer using any existing equipment to allow for easy thickness adjustment, and can hence be produced in an easier and less expensive way than a glass substrate which requires use of a flat and thin special glass sheet.

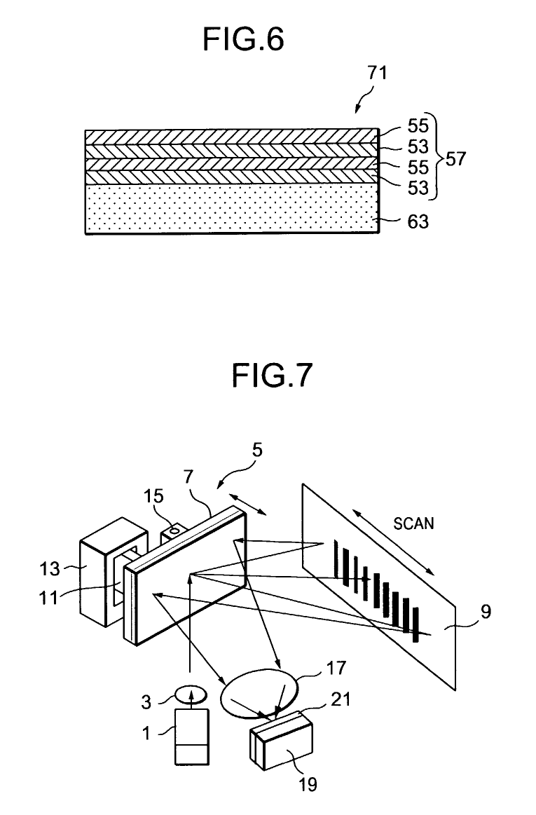

Referring next to FIG. 6, a bar code reader according to a third embodiment of the present invention will be described, in which the similar elements as in FIG. 2 are given the same reference numerals and their explanation is not duplicated.

In the bar code reader according to this embodiment, a mirror 71 of its movable mirror is made of the silicon substrate 63 and the dielectric multilayer film 57 evaporated on the silicon substrate 63.

According to this bar code reader, the dielectric multilayer film 57 yields a high reflectivity, possibly making the bar code reader smaller, lighter, and less expensive. A further cost reduction can be achieved if a low-sensitivity, inexpensive light receiving element 45 is employed, whereas an increased photosensitivity can be obtained if the light receiving element 45 has the same sensitivity as known light receiving elements. Moreover, an active enhanced reflection of beams having a target wavelength band can make the bar code reader less susceptible to extraneous light than ever before, to improve the reliability of bar code reading.

Furthermore, using a silicon substrate, the movable mirror can be lighter in weight and more rigid than those made of a glass substrate. The lighter structure of the movable mirror will help reduce driving power consumption, which in turn permits use of a smaller driving means for realization of a smaller, lighter bar code reader. The lighter movable mirror also permits high-speed and high-response operation. The highly strong mirror substrate made of silicon is also highly impact resistant, and its thickness is readily adjustable using any existing equipment, allowing for easier and less expensive fabrication, as compared to mirror substrates made of special glass.

Another advantage of this bar code reader is that the silicon substrate produces less noise within the movable mirror than a glass substrate. When stacked on a glass substrate, a reflector film such as the dielectric multilayer film 57 produces, unlike, for example, an aluminum reflector film which is less light-transmissive and hence less problematical, unreflected rays of light which, transmitting through the dielectric multilayer film 57, enter the glass substrate to become unwanted light affecting optical signals as noise through reflection from the lower surface of the glass substrate. By contrast, the silicon substrate, which is less light-transmissive than the glass substrate, produces no such unwanted light as produced in the glass substrate, even when combined with a dielectric multilayer reflector film. Thus, the bar code reader according to this embodiment having the silicon mirror substrate can reduce noise in the movable mirror and hence improve its bar code reading reliability.

While the above-disclosed embodiments refer to bar code readers, the invention may likewise be applicable to similar scanning mirrors made of a microfabricated silicon base member using a semiconductor fabrication process such as a MEMS (Micro Electro-Mechanical Systems) process.

What is claimed is:

1. A bar code reader comprising:
a light emitting element;
a movable mirror operative, by oscillation, to reflect outgoing light from said light emitting element to cause reflected light to scan an object to be illuminated and to further reflect said reflected light of said outgoing light having illuminated said object; and
a light receiving element arranged to detect the reflected light reflected off said movable mirror and to convert a detected beam into an electrical signal,
wherein said movable mirror comprises:
a glass substrate, and
a dielectric multilayer film laminated on said glass substrate, said dielectric multilayer film being formed by alternating layers of a high refractive index material and a low refractive index material at an optical thickness λ/4, where λ is a wavelength of said outgoing light.

2. A bar code reader comprising:
a light emitting element;
a movable mirror operative, by oscillation, to reflect outgoing light from said light emitting element to cause reflected light to scan an object to be illuminated and to further reflect said reflected light of said outgoing light having illuminated said object; and
a light receiving element arranged to detect said reflected light reflected off said movable mirror and to convert a detected beam into an electrical signal,
wherein said movable mirror comprises:
a silicon substrate; and
a metallic reflector evaporated on said silicon substrate.

3. A bar code reader comprising:
a light emitting element;
a movable mirror operative, by oscillation, to reflect outgoing light from said light emitting element to cause reflected light to scan an object to be illuminated and to further reflect said reflected light of said outgoing light having illuminated said object; and
a light receiving element arranged to detect said reflected light reflected off said movable mirror and to convert a detected beam into an electrical signal,
wherein said movable mirror comprises:
a silicon substrate; and
a dielectric multilayer film laminated on said silicon substrate, said dielectric multilayer film being formed by alternating layers of a high refractive index material and a low refractive index material at an optical thickness λ/4, where λ is a wavelength of said outgoing light.
